(19) United States
(12) Patent Application Publication
(10) Pub. No.: US 2006/0190825 A1
(43) Pub. Date: Aug. 24, 2006

(54) Method and apparatus for presenting services according to a context of use

(75) Inventor: Bert Van Der Zaag, Coconut Creek, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 11/067,152

(22) Filed: Feb. 24, 2005

(51) Int. Cl. G06F 9/00

(52) U.S. Cl. 715/745; 715/866; 715/747; 715/966

(57) ABSTRACT

A device (100) employs a method (300) comprising the steps of defining (302) a context of use, according to the context of use, selecting (304) one or more services, combining (306) functions of the one or more services into an application, and presenting (308) a user interface (UI) on the device representative of the one or more services with combined functions.

### FIELD OF THE INVENTION

This invention relates generally to software application methods, and more particularly to a method and apparatus for presenting services according to a context of use.

### BACKGROUND OF THE INVENTION

Software applications operating on laptops and desktop computers provide a means to tailor the UI (User Interface) presented to an end user. However, such tailoring is typically generic once it is established. That is, once a UI is defined it is not generally adaptable to changes in the context of use of an end user.

### SUMMARY OF THE INVENTION

Embodiments in accordance with the invention provide methods and apparatus for presenting services according to a context of use.

In a first embodiment of the present invention, a computer-readable storage medium employs computer instructions for selecting according to a context of use one or more services of a corresponding one or more applications, combining functions of the one or more services into an application, and presenting a user interface (UI) according to the application.

In a second embodiment of the present invention, a device has a display, a memory, an input port, and a processor coupled to the foregoing components. The processor is programmed to select according to a context of use one or more services of a corresponding one or more applications, combine functions of the one or more services into an application, and present on the display a user interface (UI according to the application.

In a third embodiment of the present invention, a device employs a method that includes the steps of defining a context of use, selecting according to the context of use one or more services of a corresponding one or more applications, combining functions of the one or more services into an application, and presenting a UI on the device according to the application.

### BRIEF DESCRIPTION OF THE DRAWINGS

FIG. 1 is a block diagram of a device in accordance with an embodiment of the present invention.

FIGS. 2-4 illustrate multiple embodiments of a UI according to a defined context of use in accordance with an embodiment of the present invention.

FIG. 5 is a flow chart depicting a method operating in a device such as a selective call receiver (SCR) in accordance with an embodiment of the present invention.

### DETAILED DESCRIPTION

While the specification concludes with claims defining the features of embodiments of the invention that are regarded as novel, it is believed that the embodiments of the invention will be better understood from a consideration of the following description in conjunction with the figures, in which like reference numerals are carried forward.

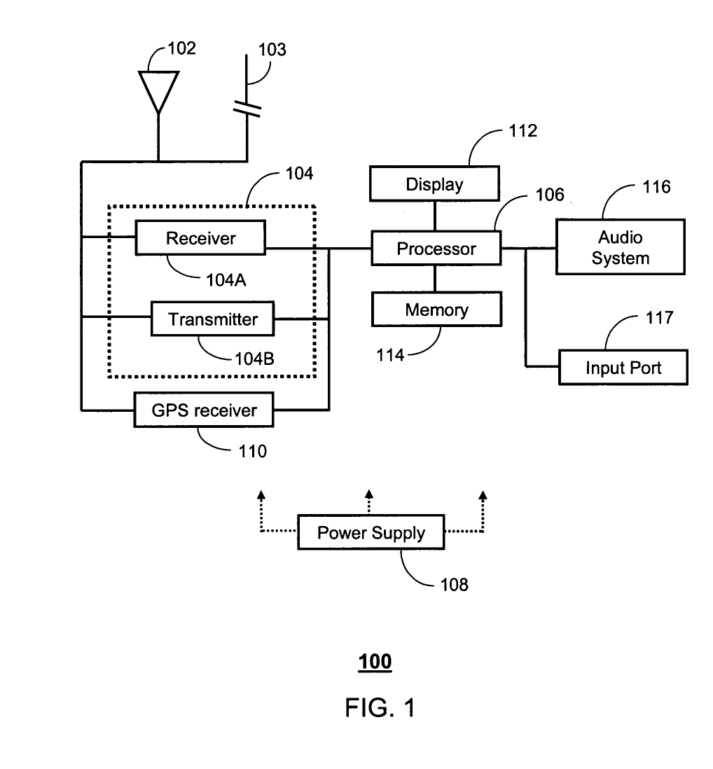

FIG. 1 is a block diagram of a device 100 in accordance with an embodiment of the present invention. In its simplest embodiment, the device 100 has conventional technology comprising a display 112, a memory 114, an input port 117, a processor 106 and a conventional power supply 108 for supplying power to the foregoing components under the control of the processor 106. The processor 106 comprises a conventional microprocessor and/or DSP (Digital Signal Processor) for processing one or more conventional services of a corresponding one or more applications. An application in the present context means a software program providing services generally supplied by the program. Services in the present context mean any functional subunit of an application. For example, a phone book application can provide services for 1) storage of contacts, 2) caller ID translation to a name of a caller in the phone book and displaying said name on a display of a mobile device, 3) short message services addressed by phone book name, and so on.

The memory 114 comprises one or more conventional memory components such as a DRAM (Dynamic Random Access Memory), a non-volatile Flash memory, or other storage means for storing the aforementioned applications and for general data processing. The display 112 comprises a conventional component such as a color LCD (Liquid Crystal Display) for displaying graphics and text in color. The input port 117 can comprise a conventional keypad with navigation capability for defining a context of use, for example, by way of a UI presented by the processor 106 on the display 112.

In a supplemental embodiment, the device 100 further comprises singly or in combination conventional components such as a receiver 104A, a transmitter 104B, a GPS (Global Positioning System) receiver 110, and an audio system 116. The transmitter 104B and the receiver 104A utilize conventional technology, which together provide the function of a transceiver 104 for exchanging messages with a conventional communication system. Communications can take place wirelessly by way of connectivity to a conventional antenna 102, or tethered with connectivity to a conventional electrical or optical wired link 103.

In the wireless embodiment, the communication system can provide long-range communication services such as is provided in a cellular network utilizing conventional protocols like the iDEN™ protocol for full and half duplex communications, the CDMA (Code Division Multiple Access) protocol, the TDMA (Time Division Multiple Access) protocol, or the GSM (Global System for Mobile communications) protocol. Any one of these protocols among others can be used for exchanging messages between devices 100. For mid to short range communications a system such as IEEE 802.11 or Bluetooth™ can be utilized to communicate by way of the Internet. In the tethered embodiment, the wired link 103 can be a conventional Ethernet link, or modem line coupled to local phone or cable service for communicating by way of the Internet.

The GPS receiver 110, which is also coupled to the antenna 102, utilizes conventional technology for processing signals from GPS satellites roaming the Earth to determine a position of the device 100. The audio system 116 utilizes conventional technology for processing under the control of the processor 106 audio signals received from an end user of the device 100 and for presenting audio signals to the end user from applications operating on the device 100.

The aforementioned components of the device 100 can represent any one of several embodiments including, but not limited to, a computer, a PDA (Personal Digital Assistant), and a mobile communications device such as a selective call radio (SCR) (hereinafter referred to as SCR 100).

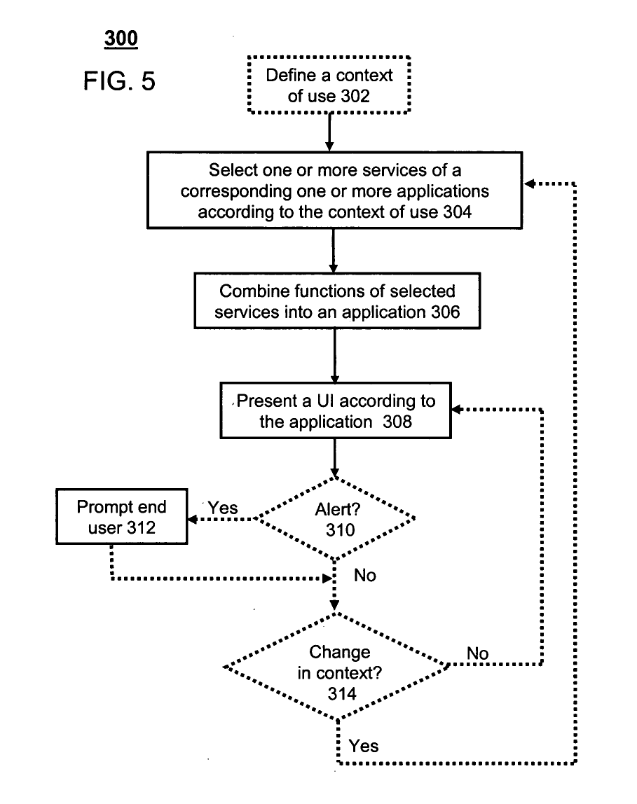

The processor 106 is programmed according to a method 300 depicted by the flowchart in FIG. 5 in accordance with an embodiment of the present invention. The method 300 begins with step 302 where a context of use is defined for an end user of the SCR 100. In a first embodiment, this step can be defined prior to storing computer instructions in the memory 114 of the SCR 100 (represented by the dashed lines of said step). For example, individuals with human factors knowledge can study the behavior of a particular demographic segment of consumers (e.g., realtors, construction personnel, family, etc.) and define for each a context of use applicable to the behavior of said consumers. From this context of use, computer programmers can develop computer instructions that follow the subsequent steps defined by method 300 as will be explained shortly.

Alternatively, or as a supplement to the foregoing embodiment, the context of use can be defined by a user of the SCR 100 by way of, for example, a definable profile or a UI providing such user with a means to execute steps 304-308 as will be detailed below. In yet another or supplemental embodiment, the context of use can be defined by the SCR 100 according to the use behavior observed of such user. Returning to method 300, in step 304, one or more conventional services of a corresponding one or more applications are selected according to the context of use. As noted earlier, each application can provide a number of services (i.e., sub-functional units of the application), which are selectable in this step by a computer programmer, an end user of the SCR 100, and/or according to the use behavior monitored by the SCR 100. Moreover, one or more of these services can reside in a second device such as a computer server on the Internet operating one or more applications with corresponding selectable services. In step 306, functions of the selected services are combined into an application. Programmers who define computer instructions for such combination of functions can develop this application, and a UI depicting the context of use defined in step 302. Alternatively, the application can be dynamically created. That is, the application can be redefined by the end user of the SCR 100, or by an application that adapts to the use behavior of the end user of the SCR 100 as will be described shortly. In step 308, the UI is presented by way of the display 112 according to said application.

The foregoing conventional services can be supplied by any number of applications including, but not limited to, an operating system, a UI toolkit application, a calendar application, a navigation application, a search application, a timer application, a calculation application, a voice messaging application, a data messaging application, a multi-media application, a contacts application, a gaming application, a voice recognition application, a voice synthesis application, a recording application, and a recent events application.

One of ordinary skill in the art will be appreciate that there are a large number of other conventional applications with corresponding services (such as office applications) not mentioned above that can also be applied to the invention within the scope and spirit of the claims described herein.

In a supplemental embodiment, the method 300 further comprises the steps of prompting the end user of the SCR 100 in step 312 when alert information is presented in the UI at step 310 according to the context of use defined in step 302. The prompt can be an audible alert presented by the audio system 116 and/or a visual alert presented by the display 112. The processor 106 can be further programmed in step 314 to detect a change in the context of use. That is, the context of use can be adapted to a use behavior of the end user of the SCR 100. The use behavior can be proactively defined by the end use of the SCR 100 by way of a UI that offers means to process method 300 according to the new context of use, or by the application developed in step 306 adapting to the use behavior of the end user as monitored. When a change in context of use is detected, the processor 106 is programmed to repeat the selecting, combining and presenting steps (304-308) according to the adapted context of use.

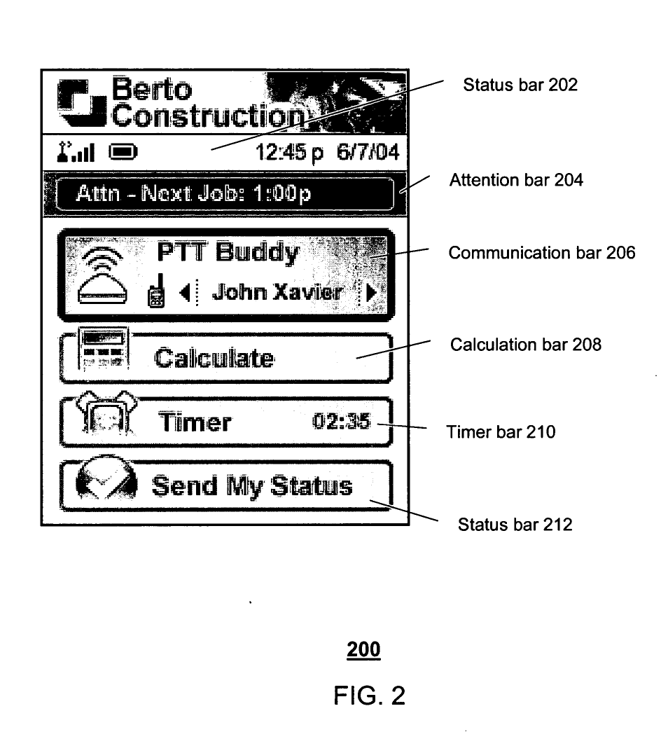

FIGS. 2-4 illustrate multiple embodiments of a UI operating according to method 300 as presented in FIG. 5. FIG. 2 illustrates a UI defined for Berto Construction (a hypothetical construction company) according to the company's context of use. The UI can be defined by an end user of the SCR 100, an administrator of the Berto Construction company, by programmers of the manufacturer of the SCR 100, and/or by the provider of services for the SCR 100 according to a context of use defined in step 302. In this example, the UI for Berto Construction provides a status bar 202 that indicates signal strength for wireless communications, remaining battery capacity of the SCR 100, time, and date. These status indicators can be supplied by services of the operating system of the SCR 100.

The UI further provides an attention bar 204 depicting scheduled information such as a next job alert. This alert can be supplied to the SCR 100 by, for example, a computer administered by personnel of Berto Construction that sends conventional SMSs (Short Message Services) to the SCR 100, which in turn are processed by the processor 106 and presented as a visual alert prompt, and if desired by the end user of the SCR 100, combined with an audible alert. The message alert can also be coupled to a destination link (e.g., a URL—Uniform Resource Locator) embedded in the SMS message, which provides, for example, an address to the next job site.

Referring back to step 306, services of the applications operating in the SCR 100 that were selected in step 304 can be combined into an application to support the foregoing attention bar 204. For example, the alert service of the calendar application can be combined with the SMS parsing service of the data messaging application. Information is exchanged by these combined services according to the context of use. For instance, the SMS parsing service can be called on by the processor 106 to parse timing information from the SMS message, which it then provides to the alert service to present an alert prompt as described in step 312.

Similarly, if the destination link is selected by the end user from the SMS message corresponding to the attention bar 204, the processor 106 can call on the SMS parsing service to parse the site address of the next job which it can then present to a select services of the navigation application (e.g., GPS receiver service, directional mapping service, and synthesized voice service). The navigation services in turn invoke the GPS receiver 110 to repeatedly determine a change in location of the SCR 100, which is then compared to a conventional map and the desired location in order to present audible synthesized voice directions on route to the destination using the voice synthesis service and the audio system 116. The tasks of the combined services of the aforementioned applications to construct the task bars 202-204 of the UI of FIG. 2 are presented in a seamless manner to the end user.

Next, the UI can also provide a communication bar 206 comprising a short list of buddies (shown here as “John Xavier” as a starting point) that can be contacted utilizing conventional PTT (Push-To-Talk) technology such as half-duplex voice messaging provided by the iDEN™ protocol. The left and right arrows can be used to scroll through the buddies list. The buddies are selected according to the context of use. For example, the processor 106 can be programmed to invoke a service of the contacts application to select only those known to be involved with the job task at hand. The selectivity of said buddies can be controlled, for example, by information provided by the end user of the SCR 100 and/or Berto Construction by way of a keypad entry and/or an SMS message providing, for example, the names of said buddies. Like in the previous task bars, the communication bar 206 comprises combined services of applications selected by the processor 106 in steps 304 and 306 according to the context of use. In this instance, services can be selected from the voice messaging application, data messaging application, and contacts application, just to mention a few.

The UI depicted in FIG. 2 presents other services that can be useful to the end user such as, for example, a calculation bar 208, a timer bar 210, and a status bar 212. The calculation bar 208 can be used for general construction calculations (e.g., calculating square footage of a construction site). Similarly, the timer bar 210 can be used for monitoring time of a specific construction task such as the time for cement to dry. The end user of the SCR 100 can select the status bar 212 to provide his or her supervisor an update of the job task by way of services selected from the data or voice messaging applications. As noted earlier, the aforementioned services are grouped in an application created in step 306, which provides a customized UI corresponding to the context of use, which can be developed from underlying services of the UI toolkit of the SCR 100.

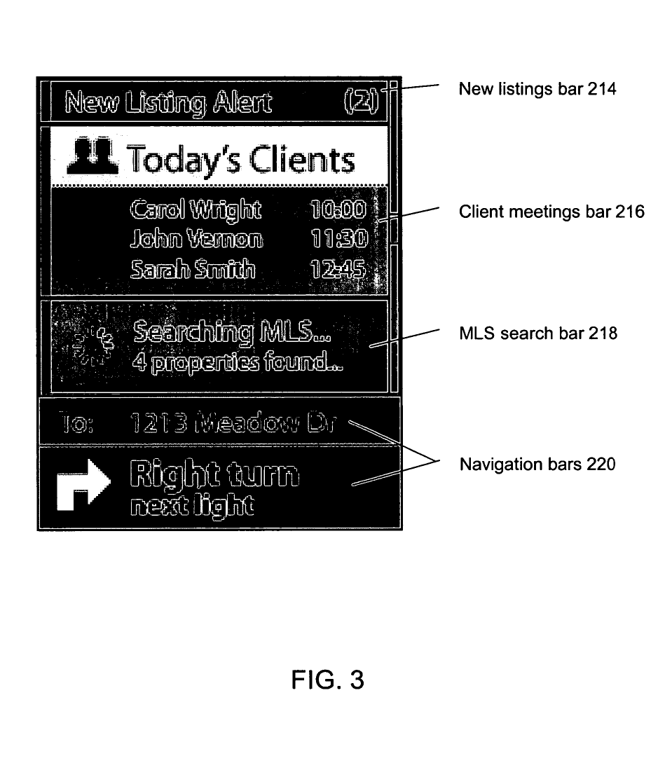

FIG. 3 provides a UI, which is the byproduct of steps 302-308 of method 300 for a context of use for a real estate agent. The UI in this illustration includes a new listings bar 214, a client meetings bar 216, an MLS (Multiple Listing Service) search bar 218, and a navigation bar 220. The new listings bar 214 provides the end user (in this case a real estate agent) an alert (such as described in steps 310-312) for new listings posted in the MLS service. The real estate agent can, for example, select the new listing bar 214 using a navigation disk of the keypad of the SCR 100 to visualize the new listings. The client meetings bar 216 provides the real estate agent a means to track client appointments. The MLS search bar 218 provides the agent a means to perform searches in the MLS system. The navigation bar 220 can provide the agent directions to a particular listing by way of simple text directions, and/or by way of real-time audible navigation directions as described for the UI of FIG. 2.

The aforementioned task bars 214-220 represent several services of the SCR 100 and a remote second device like a server of the realty company that provides the MLS service that are selected in step 304 according to the context of use, and combined in step 306 into an application that presents a seamless UI in step 308 to the end user of the SCR 100. For example, in the illustration of FIG. 3, services of the calendaring application can be combined with services of the contacts application to provide the client meeting bar 216. A searching service supplied by, for example, a searching application such as a conventional Internet browser of the SCR 100 can be combined with an SMS parsing service to process a URL supplied in an SMS provided by the agent's MLS service to provide MLS search bar 218. Navigation services combined with voice synthesis and voice recognition services can be utilized to provide a sophisticated navigation bar 220 for directions to a selected property as described earlier for FIG. 2.

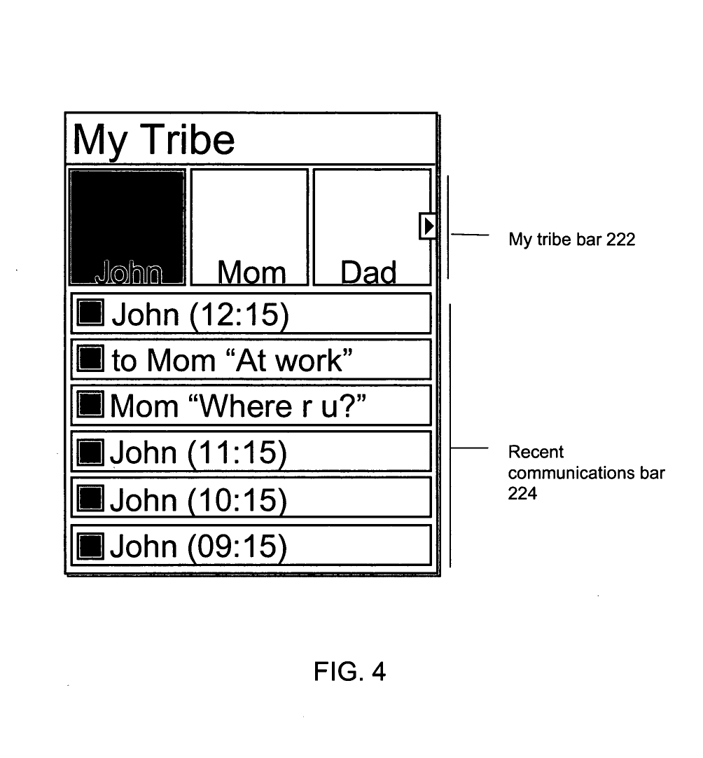

FIG. 4 provides yet another example of a UI defined by method 300 according to a context of use represented here by a tribe of family and friends of the end user. The tribe bar 222 displays a limited set of tribe members the end user can communicate with utilizing the SCR 100. Other tribe members can be selected by scrolling to the right with the selection of the right arrow. The recent communications bar 224 provides a status of the end user's recent voice and data communications with his or her tribe members. Like the prior UI illustrations of FIGS. 2-3, steps 304-308 define the UI according to the services selected and combined into a customized application. Given the simplicity of this UI, the services selected can come from, for example, the voice and data messaging applications, the timer application, and contacts application.

The UI's of FIGS. 2-4 can also be adapted to a change in context of use as noted in step 314 of FIG. 5 by the end user of the SCR 100, and/or by an application of step 306 that is designed to be adaptable to the use behavior of the end user. The processor 106, therefore, can be programmed to monitor the use behavior of the end user of the SCR 100 and thereby adapt the UI by repeating steps 304-308 according to the adapted context of use.

It should be evident to the reader that the present invention can be realized in hardware, software, or a combination of hardware and software. Moreover, the present invention can be realized in a centralized fashion, or in a distributed fashion where services are spread across multiple processing units some of which reside in the SCR 100 and others which reside in remote devices such as conventional servers. Any kind of device or other apparatus adapted for carrying out the methods described herein is suited.

Additionally, the present invention can be embedded in a computer program product, which comprises all the features enabling the implementation of the methods described herein, and which when loaded in a computer system is able to carry out these methods as computer instructions. A computer program in the present context means any expression, in any language, code or notation, of a set of instructions intended to cause a system having an information processing capability to perform a particular function either directly or after either or both of the following: a) conversion to another language, code or notation; b) reproduction in a different material form.

It should be also evident that the present invention may be used in many arrangements. Thus, although the description is made for particular arrangements and methods, the intent and concept of the invention is suitable and applicable to other arrangements not described herein. For example, method 300 can be limited to steps 302-308 without departing from the scope of the claimed invention. It would be clear therefore to those skilled in the art that modifications to the disclosed embodiments described herein can be effected without departing from the spirit and scope of the invention.

Accordingly, the described embodiments ought to be construed to be merely illustrative of some of the more prominent features and applications of the invention. It should also be understood that the claims are intended to cover the structures described herein as performing the recited function and not only structural equivalents. Therefore, equivalent structures that read on the description are to be construed to be inclusive of the scope of the invention as defined in the following claims. Thus, reference should be made to the following claims, rather than to the foregoing specification, as indicating the scope of the invention.

What is claimed is:

1. A computer-readable storage medium, comprising computer instructions for:
selecting according to a context of use one or more services of a corresponding one or more applications;
combining functions of the one or more services into an application; and
presenting a user interface (UI) according to the application.

2. The storage medium of claim 1, further comprising computer instructions for exchanging information between services according to the context of use.

3. The storage medium of claim 1, further comprising computer instructions for prompting an end user of the device when alert information is presented in the UI according to the context of use.

4. The storage medium of claim 1, wherein the context of use is adaptable to a use behavior of the end user of the device, and wherein the storage medium further comprises computer instructions for repeating the selecting, combining and presenting steps according to the adapted context of use.

5. The storage medium of claim 1, wherein at least one of the one or more services operates on a second computer storage medium.

6. The storage medium of claim 1, wherein the one or more services are selected among one or more of a group of applications comprising an operating system, a UI (User Interface) toolkit application, a calendar application, a navigation application, a search application, a timer application, a calculation application, a voice messaging application, a data messaging application, a multi-media application, a contacts application, a gaming application, a voice recognition application, a voice synthesis application, a recording application, and a recent events application.

7. A device, comprising:
a display;
an input port;
a memory; and
a processor coupled to the foregoing components, wherein the processor is programmed to:
select according to a context of use one or more services of a corresponding one or more applications;
combine functions of the one or more services into an application; and
present on the display a user interface (UI) according to the application.

8. The device of claim 7, wherein the processor is further programmed to exchange information between services according to the context of use.

9. The device of claim 7, wherein the processor is further programmed to prompt an end user of the device when alert information is presented in the UI according to the context of use.

10. The device of claim 7, wherein the context of use is adaptable to a use behavior of the end user of the device, and wherein the processor is further programmed to repeat the select, combine and present steps according to the adapted context of use.

11. The device of claim 7, further comprising a receiver, wherein the processor is further programmed to engage the receiver to receive messages from a communication system according to the context of use.

12. The device of claim 7, further comprising a transmitter, wherein the processor is further programmed to engage the transmitter to transmit messages to a communication system according to the context of use.

13. The device of claim 7, further comprising a Global Positioning System (GPS) receiver, and wherein the processor is further programmed to engage the GPS receiver to receive signals from a plurality of GPS satellites to locate a position of the device according to the context of use, and wherein the one or more services are supplied by a navigation application.

14. The device of claim 7, wherein the one or more services are selected among one or more of a group of applications comprising an operating system, a UI (User Interface) toolkit application, a calendar application, a search application, a timer application, a calculation application, a multi-media application, a contacts application, a gaming application, a voice recognition application, a voice synthesis application, a recording application, and a recent events application.

15. The device of claim 7, further comprising a transceiver, wherein the processor is further programmed to engage the transceiver to transmit and receive messages to and from a communication system according to the context of use.

16. The device of claim 15, wherein the device is one among a group of devices comprising a computer, a PDA (Personal Digital Assistant), and a mobile communications device.

17. The device of claim 15, wherein at least one of the one or more services operates on a second device.

18. In a device, a method comprising the steps of:
defining a context of use;
selecting according to the context of use one or more services of a corresponding one or more applications;
combining functions of the one or more services into an application; and
presenting a user interface (UI) according to the application.

19. The method of claim 18, wherein the method further comprises the step of exchanging information between services according to the context of use.

20. The method of claim 18, wherein the context of use is adaptable to a use behavior of the end user of the device, and wherein the method further comprises the steps of repeating the selecting, combining and presenting steps according to the adapted context of use.
